(19) United States
(12) Patent Application Publication
(10) Pub. No.: US 2004/0016914 A1
(43) Pub. Date: Jan. 29, 2004

(54) Coating liquid for forming transparent conductive film, substrate with transparent conductive film, and display device

(75) Inventors: Masayuki Matsuda, Kitakyushu-shi (JP); Mitsuaki Kumazawa, Kitakyushu-shi (JP); Yoichi Ishihara, Kitakyushu-shi (JP); Toshiharu Hirai, Kitakyushu-shi (JP); Michio Komatsu, Kitakyushu-shi (JP)

Correspondence Address: Kent E. Baldauf, 700 Koppers Building, 436 Seventh Avenue, Pittsburgh, PA, 15219-1818, US

(73) Assignee: CATALYSTS & CHEMICALS INDUSTRIES CO., LTD.

(21) Appl. No.: 10/621,871

(22) Filed: Jul. 17, 2003

(30) Foreign Application Priority Data
Jul. 18, 2002 (JP) 2002-210027

(51) Int. Cl. H01C 1/00; C09D 1/00

(52) U.S. Cl. 252/500; 106/286.1; 106/286.8

(57) ABSTRACT

Disclosed is a coating liquid for forming a transparent conductive film, comprising conductive fine particles having an average particle diameter of 1 to 200 nm, silica particles having an average particle diameter of 4 to 200 nm and a polar solvent. The silica particles are in the form of chain silica particles having 2 to 10 silica particles on an average being connected. The content of an alkali in the silica particles is not more than 1000 ppm in terms of an alkali metal M. Also disclosed is a substrate with a transparent conductive film, comprising a substrate, a transparent conductive fine particle layer formed on the substrate and containing conductive fine particles having an average particle diameter of 1 to 200 nm and silica particles having an average particle diameter of 4 to 200 nm and/or chain silica particles having 2 to 10 silica particles on an average being connected, and a transparent film provided on the transparent conductive fine particle layer and having a refractive index lower than that of the transparent conductive fine particle layer. A display device using the substrate with a transparent conductive film is further disclosed. The coating liquid for forming a transparent conductive film is capable of forming a transparent conductive film having low surface resistance, excellent antistatic properties, excellent electromagnetic blocking properties, high film strength and excellent adhesion to a substrate.

### FIELD OF THE INVENTION

The present invention relates to a coating liquid for forming a transparent conductive film. The present invention also relates to a display device having a transparent conductive film.

### BACKGROUND OF THE INVENTION

For the purpose of preventing electrostatic charging and reflection on the surfaces of transparent substrates of display panels, such as cathode ray tubes, fluorescent indicator tubes and liquid crystal display plates, transparent films having antistatic function and anti-reflection function have been conventionally formed on these surfaces.

In recent years, influences of electromagnetic waves released from the cathode ray tubes or the like on human bodies have been put into problem, and in addition to the prevention of electrostatic charging or reflection, it has been desired to block the electromagnetic waves and the electromagnetic fields formed with release of the electromagnetic waves.

One method to block the electromagnetic waves is a method of forming a conductive film for blocking the electromagnetic waves on a surface of the display panel such as a cathode ray tube. In case of the conductive film for electromagnetic blocking, however, a low surface resistivity such as 10² to 10⁴ Ω/□ is necessary, though a surface resistivity of at least about 10⁷ Ω/□ is enough for the conventional antistatic conductive film.

If the conductive film having such a low surface resistivity is intended to be formed using a conventional coating liquid containing a conductive oxide such as Sb-doped tin oxide or Sn-doped indium oxide, it becomes necessary to make the film thickness larger than that of the conventional antistatic film. However, the anti-reflection effect does not appear unless the thickness of the conductive film is about 10 to 200 nm. In case of the conventional conductive oxide such as Sb-doped tin oxide or Sn-doped indium oxide, therefore, there resides a problem that it is difficult to form a conductive film having not only low surface resistance and excellent electromagnetic blocking properties but also excellent anti-reflection properties.

As a method to form a conductive film of low surface resistance, there is a method of forming a film containing metallic fine particles on the surface of a substrate using a coating liquid containing fine particles of a metal such as Ag. In this method, a dispersion of colloidal metallic fine particles in a polar solvent is employed as the coating liquid. In order to enhance dispersibility of the colloidal metallic fine particles, surfaces of the metallic fine particles for the coating liquid are treated with an organic stabilizer, such as polyvinyl alcohol, polyvinyl pyrrolidone or gelatin. However, the conductive film formed by the use of such a film-forming coating liquid has high intergranular resistance and is not decreased in the surface resistance in some cases because the metallic fine particles are in contact with one another through the stabilizer in the coating film. On this account, it is necessary to burn the film at a high temperature of about 400° C. to decompose and remove the stabilizer after the film formation. However, if the film is burned at a high temperature to decompose and remove the stabilizer, fusion or coagulation of the metallic fine particles takes place to cause lowering of transparency or haze of the conductive film. Further, in case of a cathode ray tube, a problem of film deterioration occurs when the film is exposed to high temperatures.

In the conventional transparent conductive film containing metallic fine particles such as fine particles of Ag, oxidation of the metal or particle growth due to ionization sometimes takes place, or corrosion takes place depending upon circumstances. As a result, conductivity or light transmittance of the film is lowered to bring about a problem that the display device lacks reliability.

For the transparent conductive film, improvement in adhesion to the substrate and strength are also required.

The present inventors have earnestly studied to solve such problems associated with the prior art as described above, and as a result, they have found that a transparent conductive film containing silica particles is excellent in adhesion to the substrate and strength and has low surface resistance. Based on the finding, the present invention has been accomplished.

### OBJECT OF THE INVENTION

It is an object of the present invention to provide a coating liquid for forming a transparent conductive film, which is capable of forming a transparent conductive film having low surface resistance, excellent antistatic properties, excellent electromagnetic blocking properties, high film strength and excellent adhesion to a substrate, and a display device having such a transparent conductive film.

### SUMMARY OF THE INVENTION

The coating liquid for forming a transparent conductive film according to the present invention comprises conductive fine particles having an average particle diameter of 1 to 200 nm, silica particles having an average particle diameter of 4 to 200 nm, and a polar solvent.

The silica particles are preferably in the form of chain silica particles having 2 to 10 silica particles on an average being connected.

The content of an alkali in the silica particles is preferably not more than 1000 ppm in terms of an alkali metal M.

The weight ratio (WB)/(WA) of the silica particles (WB) to the conductive fine particles (WA) is preferably in the range of 0.01 to 0.4.

The conductive fine particles are preferably metallic fine particles of one or more metals selected from the group consisting of Au, Ag, Pd, Pt, Rh, Ru, Cu, Fe, Ni, Co, Sn, Ti, In, Al, Ta and Sb.

The substrate with a transparent conductive film according to the present invention comprises a substrate, a transparent conductive fine particle layer formed on the substrate and comprising conductive fine particles having an average particle diameter of 1 to 200 nm and silica particles having an average particle diameter of 4 to 200 nm and/or chain silica particles having 2 to 10 silica particles on an average being connected, and a transparent film provided on the transparent conductive fine particle layer and having a refractive index lower than that of the transparent conductive fine particle layer.

The display device according to the present invention includes a front side plate constituted of the above-mentioned substrate with a transparent conductive film, said transparent conductive film being present on the outer surface side of the front side plate.

### DETAILED DESCRIPTION OF THE INVENTION

The present invention is described in detail hereinafter.

### Coating Liquid for Forming Transparent Conductive Film

First, the coating liquid for forming a transparent conductive film according to the invention is described.

The coating liquid for forming a transparent conductive film according to the invention comprises conductive fine particles having an average particle diameter of 1 to 200 nm, silica particles having an average particle diameter of 4 to 200 nm, and a polar solvent.

### Conductive Fine Particles

The conductive fine particles for use in the invention are preferably metallic fine particles of one or more metals selected from the group consisting of Au, Ag, Pd, Pt, Rh, Ru, Cu, Fe, Ni, Co, Sn, Ti, In, Al, Ta and Sb. Examples of metallic fine particles of two or more metals include fine particles of Au—Cu, Ag—Pt, Ag—Pd, Au—Pd, Au—Rh, Pt—Pd, Pt—Rh, Fe—Ni, Ni—Pd, Fe—Co, Cu—Co, Ru—Ag, Au—Cu—Ag, Ag—Cu—Pt, Ag—Cu—Pd, Ag—Au—Pd, Au—Rh—Pd, Ag—Pt—Pd, Ag—Pt—Rh, Fe—Ni—Pd, Fe—Co—Pd and Cu—Co—Pd. Two or more metals may be an alloy in a solid solution state or may be an eutectic crystal that is not in a solid solution state, or an alloy and an eutectic crystal may coexist. In case of such composite metallic fine particles, oxidation or ionization of metals is inhibited, and thereby the particle growth of the composite metallic fine particles is also inhibited. Consequently, the composite metallic fine particles have high reliability, such as high corrosion resistance and small decrease in the conductivity and light transmittance.

The average particle diameter of the conductive metallic fine particles is desired to be in the range of 1 to 200 nm, preferably 2 to 70 nm. If the average particle diameter of the conductive metallic fine particles exceeds 200 nm, light absorption by the metal is increased, whereby the light transmittance of the particle layer is lowered and the haze thereof is increased. Accordingly, if a substrate with such a film is used as a front side plate of a cathode ray tube, resolution of the display image may be lowered. If the average particle diameter of the conductive fine particles is less than 1 nm, the surface resistance of the particle layer is steeply increased, and as a result, it sometimes becomes impossible to obtain a film having such a low resistivity as to be capable of attaining the object of the present invention.

The conductive fine particles can be prepared by the following known process, without limiting thereto.

For example, the conductive fine particles can be obtained by reducing a salt of one or more kinds of the aforesaid metals in an alcohol/water mixed solvent. In the reduction, a reducing agent may be added when needed, and examples of the reducing agents include ferrous sulfate, trisodium citrate, tartaric acid, sodium boron hydride and sodium hypophosphite. In the above process, heat treatment at a temperature of not lower than about 100° C. may be carried out in a pressure vessel.

### Silica Particles

In the present invention, silica particles are used together with the conductive fine particles.

By the use of the silica particles in combination, conductivity of the resulting conductive film can be enhanced. Although the reason why the conductivity is enhanced is not clear, it is considered that the conductive fine particles tend to be connected to one another along the silica particles, and hence, electrical conduction among the particles easily occur to thereby enhance the conductivity.

The silica particles (primary particles in case of the later-described connected particles) for use in the invention have an average particle diameter of preferably 4 to 200 nm, more preferably 5 to 100 nm.

If the average particle diameter of the silica particles is less than the lower limit of the above range, it is difficult to obtain the particles. Even if the silica particles are obtained, electrical conduction is inhibited because they are coagulated around the conductive fine particles or present in the gaps among the conductive fine particles.

If the average particle diameter of the silica particles exceeds the upper limit of the above range, haze of the transparent conductive film tends to be deteriorated.

The average particle diameter (Ps) of the silica particles used is preferably larger than the average particle diameter (Pc) of the conductive fine particles. Specifically, the (Ps)/(Pc) ratio is preferably not less than 1.2, more preferably not less than 1.5. When the average particle diameter of the silica particles is larger than the average particle diameter of the conductive fine particles, arrangement of the conductive fine particles around the silica particles and contact of the conductive fine particles or connection thereof are promoted, whereby the conductivity is further enhanced.

The silica particles for use in the invention are preferably in the form of chain silica particles having 2 to 10 silica particles, preferably 3 to 8 silica particles, on an average being connected.

By the use of such chain silica particles, the conductive fine particles tend to be connected in the S form of a chain along the chain silica particle. On this account, enhancement of the conductivity (decrease of surface resistance) of the resulting transparent conductive film tends to be conspicuous.

The process for preparing the silica particles for use in the invention is not specifically restricted as long as the resulting silica particles have an average particle diameter of the above range, and any of hitherto known processes is adoptable. In particular, silica sols disclosed in Japanese Patent Laid-Open Publication No. 45114/1988 and Japanese Patent Laid-Open Publication No. 64911/1988 are uniform in the silica particle diameters and are excellent in the stability, so that they can be favorably employed.

The chain silica particle wherein the silica particles are connected in the form of a chain can also be prepared by hitherto known processes. For example, concentration or pH of a monodisperse silica particle dispersion is controlled, and the dispersion is subjected to hydrothermal treatment at a high temperature such as not lower than 100° C. In this process, a binder component may be added to promote connection of the particles, when needed. Short fibrous silica disclosed in Japanese Patent Laid-Open Publication No. 61043/1999 can also be preferably employed.

The chain silica particles obtained as above may be subjected to classification prior to use, if desired.

In the silica particles, the content of an alkali is in the range of preferably not more than 1000 ppm, more preferably not more than 200 ppm, particularly preferably not more than 100 ppm, in terms of an alkali metal M.

If the content of an alkali in the silica particles is too much, the resulting transparent conductive film sometimes receives bad influences of the alkali, such as inhibition of electrical conduction.

The silica particles having such a low alkali content can be obtained from the silica sol by optionally treating it with an ion exchange resin or the like. The silica sol thus dealkalized or a silica sol obtained by the use of a material containing no alkali has a low alkali content, and hence bad influences of the alkali on the resulting transparent conductive film, such as inhibition of electrical conduction, are reduced.

In the conductive fine particle layer, the ratio (WB)/(WA) of the silica particle weight (WB) to the conductive fine particle weight (WA) is in the range of preferably 0.01 to 0.4, more preferably 0.05 to 0.3.

If the weight ratio is less than the lower limit of the above range, the effect of the invention such as improvement in adhesion of the resulting transparent conductive film to the substrate or improvement in strength of the resulting transparent conductive film is not obtained in some cases because of too small amount of the silica particles or the chain silica particles. Further, the effect in the improvement of electrical conduction is not obtained in some cases.

If the weight ratio exceeds the higher limit of the above range, electrical conduction is sometimes lowered because of too large amount of the silica particles which are insulating particles and too small proportion of the conductive fine particles.

### Polar Solvent

Examples of the polar solvents employable in the invention include water; alcohols, such as methanol, ethanol, propanol, butanol, diacetone alcohol, furfuryl alcohol, tetrahydrofurfuryl alcohol, ethylene glycol and hexylene alcohol; esters, such as methyl acetate and ethyl acetate; ethers, such as diethyl ether, ethylene glycol monomethyl ether, ethylene glycol monoethyl ether, ethylene glycol monobutyl ether, diethylene glycol monomethyl ether and diethylene glycol monoethyl ether; and ketones, such as acetone, methyl ethyl ketone, acetyl acetone and acetoacetate. These solvents may be used singly or in combination of two or more kinds.

### Composition of Coating Liquid

In the coating liquid for forming a transparent conductive film, the metallic fine particles are desirably contained in amounts of 0.05 to 5% by weight, preferably 0.1 to 2% by weight.

In the coating liquid, conductive fine particles other than the metallic fine particles may be further contained.

As the conductive fine particles, fine particles of a transparent conductive inorganic oxide publicly known, fine particle carbon and the like are employable.

Examples of the fine particles of transparent conductive inorganic oxides include those of tin oxide, tin oxide doped with Sb, F or P, indium oxide, indium oxide doped with Sn or F, antimony oxide and lower titanium oxide.

The average particle diameter of the fine particles of a conductive inorganic oxide is desired to be in the range of 1 to 200 nm, preferably 2 to 150 nm.

The amount of the silica particles (total amount of the silica particles and the inorganic oxide fine particles in the case where the inorganic oxide fine particles are contained) has only to be in the range of 0.01 to 0.4 part by weight based on 1 part by weight of the metallic fine particles. If the amount thereof exceeds the above range, the effect in the improvement of electrical conduction owing to the arrangement of the metallic fine particles around the silica particles is not obtained in some cases.

By the addition of such fine particles of a conductive inorganic oxide, a transparent conductive fine particle layer superior in the transparency to a transparent conductive fine particle layer formed from metallic fine particles and silica particles can be formed. By the addition of the fine particles of a conductive inorganic oxide, further, a substrate with a transparent conductive film can be produced inexpensively.

To the coating liquid, dyes or pigments may be added to make the visible light transmittance constant in the wide wavelength region of visible light.

In the coating liquid according to the invention, the solids concentration (total amount of the metallic fine particles, the silica particles, and additives optionally added, such as conductive fine particles other than the metallic fine particles, dyes and pigments) is desired to be not more than 15% by weight, preferably 0.15 to 5% by weight, from the viewpoints of flowability of the liquid and dispersibility of the particle components such as metallic fine particles in the coating liquid.

In the coating liquid according to the invention, a matrix component functioning as a binder of the conductive fine particles after the film formation may be contained. The matrix component is preferably a component comprising silica, and examples thereof include a hydrolysis polycondensate of an organosilicon compound such as alkoxysilane, a silicic acid polycondensate obtained by dealkalization of an alkali metal silicate aqueous solution, and a coating resin. The matrix component has only to be contained in an amount of 0.01 to 0.5 part by weight, preferably 0.03 to 0.3 part by weight, based on 1 part by weight of the total of the metallic fine particles, the silica particles and the transparent conductive fine particles.

In the coating liquid, the matrix component is desirably contained in an amount of 0.1 to 2% by weight, preferably 0.01 to 1% by weight.

In order to enhance dispersibility of the metallic fine particles, an organic stabilizer may be contained in the coating liquid for forming a transparent conductive film. Examples of the organic stabilizers include gelatin, polyvinyl alcohol, polyvinyl pyrrolidone, polycarboxylic acids, such as oxalic acid, malonic acid, succinic acid, glutaric acid, adipic acid, sebacic acid, maleic acid, fumaric acid, phthalic acid and citric acid, salts of the polycarboxylic acids, and mixtures thereof.

The organic stabilizer has only to be contained in an amount of 0.005 to 0.5 part by weight, preferably 0.01 to 0.2 part by weight, based on 1 part by weight of the metallic fine particles. If the amount of the organic stabilizer is too little, dispersibility of the coating liquid deteriorates. If the amount thereof is too much, electrical conduction of the obtained film is sometimes inhibited.

### Substrate with Transparent Conductive Film

Next, the substrate with a transparent conductive film according to the invention is described in detail.

In the substrate with a transparent conductive film according to the invention, a transparent conductive fine particle layer containing the conductive fine particles having an average particle diameter of 1 to 200 nm and the silica particles having an average particle diameter of 4 to 200 nm is formed on a substrate, such as a film, a sheet or another molded product made of glass, plastic, ceramic or the like.

### Transparent Conductive Fine Particle Layer

The thickness of the transparent conductive fine particle layer is desired to be in the range of about 5 to 200 nm, preferably 10 to 150 nm. When the thickness is in this range, a substrate with a transparent conductive film exerting excellent electromagnetic blocking effect can be obtained.

The transparent conductive fine particle layer may further contain, in addition to the metallic fine particles and the silica particles, conductive fine particles other than the metallic fine particles, a matrix component and an organic stabilizer, for example, the same substances as previously described.

### Transparent Film

In the substrate with a transparent conductive film according to the invention, a transparent film having a refractive index lower than that of the transparent conductive fine particle layer is formed on the transparent conductive fine particle layer.

The thickness of the transparent film is desired to be in the range of 50 to 300 nm, preferably 80 to 200 nm.

The transparent film is formed from, for example, an inorganic oxide, such as silica, titania or zirconia, or a composite oxide thereof. In the present invention, the transparent film is preferably a silica type film composed of a hydrolysis polycondensate of a hydrolyzable organosilicon compound or a silicic acid polycondensate obtained by dealkalization of an alkali metal silicate aqueous solution. The substrate with a transparent conductive film, which further has such a transparent film, is excellent in the anti-reflection properties.

In the transparent film, additives, e.g., fine particles of a low-refractive index material such as magnesium fluoride, dyes and pigments, may be contained when needed.

### Process for Producing Substrate with Transparent Conductive Film

Next, the process for producing the substrate with a transparent conductive film is described.

The substrate with a transparent conductive film according to the invention can be produced by applying the liquid for forming a transparent conductive film onto a substrate, drying it to form a transparent conductive fine particle layer, then applying the coating liquid for forming a transparent film onto the fine particle layer to form, on the fine particle layer, a transparent film having a refractive index lower than that of the fine particle layer.

### Formation of Transparent Conductive Fine Particle Layer

For forming the transparent conductive fine particle layer, for example, the coating liquid for forming a transparent conductive layer is applied onto a substrate by a method of dipping, spinning, spraying, roll coating, flexographic printing or the like and drying the liquid at a temperature of room temperature to about 90° C.

When the matrix component is contained in the coating liquid for forming a transparent conductive film, the matrix component may be subjected to curing.

The curing can be carried out by the following methods.

(1) Thermal Curing

After the drying, the coating film is heated at a temperature of not lower than 100° C. to cure the matrix component.

(2) Electromagnetic Curing

After the coating or the drying, or during the drying, the coating film is irradiated with an electromagnetic wave having a wavelength shorter than that of visible light to cure the matrix component.

(3) Gas Curing

After the coating or the drying, or during the drying, the coating film is exposed to an atmosphere of a gas which accelerates curing reaction of the matrix component, such as ammonia, to cure the matrix component.

The thickness of the transparent conductive fine particle layer formed by the above method is preferably in the range of about 50 to 200 nm. When the thickness is in this range, a substrate with a transparent conductive film exerting excellent electromagnetic blocking effect can be obtained.

### Formation of Transparent Film

In the present invention, on the transparent conductive fine particle layer formed as above, a transparent film having a refractive index lower than that of the fine particle layer is formed.

The thickness of the transparent film is desired to be in the range of 50 to 300 nm, preferably 80 to 200 nm. When the thickness of the transparent film is in this range, the transparent film exhibits excellent anti-reflection properties. The method for forming the transparent film is not specifically restricted, and various methods are adoptable according to the material of the transparent film. For example, there can be adopted dry thin film-forming methods, such as vacuum deposition, sputtering and ion plating, and wet thin film-forming methods, such as the aforesaid dipping, spinning, spraying, roll coating and flexographic printing.

When the transparent film is formed by the wet thin film-forming method, a hitherto known coating liquid for forming a transparent film can be employed. The coating liquid for forming a transparent film employable is, for example, a coating liquid containing an inorganic oxide, such as silica, titania or zirconia, or a composite oxide thereof.

In the present invention, preferable is a silica type coating liquid for forming a transparent film, which contains a hydrolysis polycondensate of a hydrolyzable organosilicon compound or a silicic acid polycondensate obtained by dealkalization of an alkali metal silicate aqueous solution. Particularly preferable is a coating liquid containing a hydrolysis polycondensate of alkoxysilane represented by the following formula [1]. The silica type film formed from such a coating liquid has a refractive index lower than that of a conductive fine particle layer comprising metallic fine particles and silica particles, and the resulting substrate with a transparent film is excellent in the anti-reflection properties.

The above-mentioned silica type coating liquid for forming a transparent film enters the gaps formed in the conductive fine particle layer and is easily joined to the silica particles or the substrate. Hence, the resulting transparent film has high strength. Further, when the coating liquid having reached the substrate is cured, the resulting film exhibits excellent adhesion properties. The silica type coating liquid for forming a transparent film contains the following alkoxysilane as a film component (a matrix component).

RₐSi (OR′)₄₋ₐ [1]

wherein R is a vinyl group, an aryl group, an acrylic group, an alkyl group of 1 to 8 carbon atoms, a hydrogen atom or a halogen atom, R′ is a vinyl group, an aryl group, an acrylic group, an alkyl group of 1 to 8 carbon atoms, —C₂H₄OCₙH₂ₙ₊₁ (n=1-4) or a hydrogen atom, and a is an integer of 1 to 3.

Examples of such alkoxysilanes include tetramethoxysilane, tetraethoxysilane, tetraisopropoxysilane, tetrabutoxysilane, tetraoctylsilane, methyltrimethoxysilane, methyltriethoxysilane, ethyltriethoxysilane, methyltriisopropoxysilane, vinyltrimethoxysilane, phenyltrimethoxysilane and dimethyldimethoxysilane.

When one or more of the above alkoxysilanes are hydrolyzed in, for example, a water/alcohol mixed solvent in the presence of an acid catalyst, a coating liquid for forming a transparent film, which contains a hydrolysis polycondensate of alkoxysilane, is obtained. The concentration of the film component in the coating liquid is preferably in the range of 0.5 to 2.0% by weight in terms of an oxide.

In the coating liquid for forming a transparent film for use in the invention, additives, e.g., fine particles of a low-refractive index material such as magnesium fluoride, conductive fine particles of such small amounts as not to inhibit transparency and anti-reflection properties of the resulting transparent film, dyes and pigments, may be further contained.

In the present invention, the film is formed by applying the coating liquid for forming a transparent film. If necessary, the obtained transparent film may be heated at a temperature of not lower than 150° C. during the drying or after the drying. Otherwise the uncured film may be irradiated with an electromagnetic wave having a wavelength shorter than that of visible light, such as ultraviolet light, electron rays, X rays or γ rays, or the uncured film may be exposed to an atmosphere of an inert gas such as ammonia. By the above treatments, curing of the film-forming component is promoted to increase hardness of the resulting transparent film.

### Display Device

The substrate with a transparent conductive film has a surface resistivity of about 10² to 10⁴ Ω/□ that is necessary for electromagnetic blocking, and has sufficient anti-reflection properties in the visible and near infrared regions, so that it is favorably used as a front side plate of a display device.

The display device according to the invention is a device to electrically display an image, such as a cathode ray tube (CRT), a fluorescent indicator tube (FIP), a plasma display (PDP) or a liquid crystal display (LCD), and includes a front side plate constituted of the substrate with a transparent conductive film, which has a transparent conductive fine particle layer comprising the conductive fine particles and the silica particles.

Accordingly, the front side plate has excellent scratch resistance, and it does not occur that the front side plate is easily scratched to make it difficult to see a display image. In the display device of the invention, further, the surface resistance can be decreased, so that the electromagnetic wave and the electromagnetic field formed with the release of the electromagnetic wave can be effectively blocked.

If reflected light occurs on a front side plate of a display device, the reflected light makes it difficult to see the display image. In the display device of the invention, however, the front side plate is constituted of the substrate with a transparent conductive film having sufficient anti-reflection properties in the visible and near infrared regions, and hence, such reflected light can be effectively prevented.

### EFFECT OF THE INVENTION

Since the coating liquid for forming a transparent conductive film according to the invention contains conductive fine particles and silica particles, it can form a transparent conductive film having low surface resistance, excellent antistatic properties, excellent electromagnetic blocking properties, high film strength and excellent adhesion to a substrate.

According to the invention, a substrate with a transparent conductive film having excellent adhesion to the substrate, high film strength and excellent electrical conduction, and a display device having a front side plate constituted of the substrate with a transparent conductive film can be provided.

### EXAMPLE

The present invention is further described with reference to the following examples, but it should be construed that the invention is in no way limited to those examples.

### EXAMPLE 1

### Preparation of Dispersion of Silica Particles (A)

To 2000 g of a silica sol (SI-550, available from Catalysts & Chemicals Industries Co., Ltd., average particle diameter: 5 nm, SiO₂ concentration: 20% by weight, Na in silica: 2700 ppm), 6000 g of ion exchange water was added, then 400 g of a cation exchange resin (SK-1BH, available from Mitsubishi Chemical Corporation) was added, and they were stirred for 1 hour to perform dealkalization. After the cation exchange resin was separated, 400 g of an anion exchange resin (SANUPC, available from Mitsubishi Chemical Corporation) was added, followed by stirring for 1 hour to perform deanionization.

Subsequently, 400 g of a cation exchange resin (SK-1BH, available from Mitsubishi Chemical Corporation) was added again, followed by stirring for 1 hour to perform dealkalization. Thus, a dispersion of silica particles (A) having a SiO₂ concentration of 5% by weight was prepared. The Na content in the silica particles was 200 ppm.

### Preparation of Dispersion of Metallic Fine Particles (1)

To 100 g of pure water, trisodium citrate was added in an amount of 0.01 part by weight based on 1 part by weight of the resulting metallic fine particles. Then, an aqueous solution of silver nitrate and palladium nitrate was added in such an amount that the concentration in terms of the total metals became 10% by weight and the weight ratio of Ag/Pd became 8/2. Further, an aqueous solution of ferrous sulfate equimolar with the total of silver nitrate and palladium nitrate was added, followed by stirring for 1 hour in a nitrogen atmosphere to obtain a dispersion of composite metallic fine particles. The resulting dispersion was washed with water by means of a centrifugal separator to remove impurities, and the remainder was dispersed in water to prepare a dispersion of metallic fine particles (1). The average particle diameter of the metallic fine particles was 8 nm and the concentration of the dispersion was 10% by weight.

### Preparation of Coating Liquid for Forming Transparent Film

A mixed solution of 50 g of ethyl orthosilicate (SiO₂: 28% by weight), 194.6 g of ethanol, 1.4 g of concentrated nitric acid and 34 g of pure water was stirred for 5 hours at room temperature to prepare a liquid containing a transparent film-forming component and having a SiO₂ concentration of 5% by weight. Then, a mixed solvent of ethanol/butanol/diacetone alcohol/isopropanol (mixing ratio: 2:1:1:5 by weight) was added to obtain a coating liquid for forming a transparent film having a SiO₂ concentration of 1% by weight.

### Preparation of Coating Liquid (1) for Forming Transparent Conductive Film

The dispersion of metallic fine particles (1), the dispersion of silica particles (A) and a polar solvent (water: 82% by weight, butyl cellosolve: 16% by weight, N-methyl-pyrrolidone: 2% by weight) were mixed in such amounts that the WB/WA weight ratio became 0.15, to prepare a coating liquid (1) for forming a transparent conductive film having a solids concentration of 0.4% by weight.

### Preparation of Substrate (1) with Transparent Conductive Film

The coating liquid (1) for forming a transparent conductive film was applied onto the surface of a panel glass (14″) for a cathode ray tube by a spinning method under the conditions of 100 rpm and 90 seconds with maintaining the surface of the panel glass at 40° C., and then dried. Subsequently, onto the resulting transparent fine particle layer, the coating liquid for forming a transparent film was likewise applied by a spinning method under the conditions of 100 rpm and 90 seconds, followed by drying. Then, the coating film was burned at 160° C. for 30 minutes to obtain a substrate (1) with a transparent conductive film.

The surface resistivity of the substrate with a transparent conductive film was measured by a surface resistivity meter (LORESTA, manufactured by Mitsubishi Petrochemical Co., Ltd.), and the haze thereof was measured by a haze computer (3000A, manufactured by Nippon Denshoku Industries Co., Ltd.). The reflectance was measured by a reflectance meter (MCPD-2000, manufactured by Otsuka Electronics Co., Ltd.). That is to say, reflectances within the wavelength region of 400 to 700 nm were measured to determine a wavelength at which the lowest reflectance was obtained, and a reflectance at said wavelength was regarded as a bottom reflectance. A mean value of the reflectances within the wavelength region of 400 to 700 nm was regarded as a luminous reflectance.

Further, adhesion properties and film strength were measured by the following methods and evaluated based on the following criteria. The results are set forth in Table 1.

### Adhesion Properties (Eraser Test)

An eraser (1K, available from Lion Office Product Corporation) was set on the transparent film of the substrate (1). Then, under application of a load of 1±0.1 kg, the eraser was moved back and forth 25 times at a stroke of about 25 mm. The eraser dust was removed by high-pressure air each time the dust was produced.

After the eraser was moved back and forth 25 times, the surface of the anti-reflection film was visually observed at a distance of 45 cm from the surface.

A: Any scratch is not observed.

B: The reflection color changes from violet to red under a fluorescent lamp.

C: There is no reflection color under a fluorescent lamp, and scratches are observed.

D: The base (substrate) is seen.

### Measurement of Film Strength (Scratch Test)

On the transparent film of the substrate (1) with a film, a standard test needle (available from Rockwell Automation Inc., hardness: HRC-60, ψ:0.5 mm) was set. Then, under application of a load of 1±0.3 kg to the needle, the film was scratched with the needle at a stroke of 30 to 40 mm. After the scratching, the surface of the film was observed at a distance of 45 cm from the surface under illumination of 1000 lux.

A: Any scratch is not observed.

B: An intermittent scratch line is observed.

C: A shallow continuous scratch line is observed.

D: A continuous scratch line is clearly observed.

### EXAMPLE 2

### Preparation of Coating Liquid (2) for Forming Transparent Conductive Film

A coating liquid (2) for forming a transparent conductive film having a solids concentration of 0.4% by weight was prepared in the same manner as in Example 1, except that the dispersion of metallic fine particles (1), the dispersion of silica particles (A) and the polar solvent were mixed in such amounts that the WB/WA weight ratio became 0.05.

### Preparation of substrate (2) with Transparent Conductive Film

A substrate (2) with a transparent conductive film was obtained in the same manner as in Example 1, except that the coating liquid (2) for forming a transparent conductive film was used.

The surface resistivity, haze, bottom reflectance, luminous reflectance and adhesion properties of the resulting substrate (2) with a transparent conductive film were evaluated.

The results are set forth in Table 1.

### EXAMPLE 3

### Preparation of Coating Liquid (3) for Forming Transparent Conductive Film

A coating liquid (3) for forming a transparent conductive film having a solids concentration of 0.4% by weight was prepared in the same manner as in Example 1, except that the dispersion of metallic fine particles (1), the dispersion of silica particles (A) and the polar solvent were mixed in such amounts that the WB/WA weight ratio became 0.25.

### Preparation of Substrate (3) with Transparent Conductive Film

A substrate (3) with a transparent conductive film was obtained in the same manner as in Example 1, except that the coating liquid (3) for forming a transparent conductive film was used.

The surface resistivity, haze, bottom reflectance, luminous reflectance and adhesion properties of the resulting substrate (3) with a transparent conductive film were evaluated.

The results are set forth in Table 1.

### EXAMPLE 4

### Preparation of Dispersion of Silica Particles (B)

A dispersion of silica particles (A) was prepared in the same manner as in Example 1. Then, the dispersion was adjusted to pH 8 by the use of dilute ammonia water and heated at 150° C. for 16 hours in an autoclave. Subsequently, a cation exchange resin was added, followed by stirring for 1 hour to perform dealkalization. After the cation exchange resin was separated, an anion exchange resin was added, followed by stirring for 1 hour to perform deanionization. Thus, a dispersion of silica particles (B) having a SiO₂ concentration of 5% by weight was prepared. The silica particles were monodisperse, and the Na content in the silica particles was 100 ppm.

### Preparation of Coating Liquid (4) for Forming Transparent Conductive Film

A coating liquid (4) for forming a transparent conductive film having a solids concentration of 0.4% by weight was prepared in the same manner as in Example 1, except that the dispersion of silica particles (B) was used.

### Preparation of Substrate (4) with Transparent Conductive Film

A substrate (4) with a transparent conductive film was obtained in the same manner as in Example 1, except that the coating liquid (4) for forming a transparent conductive film was used.

The surface resistivity, haze, bottom reflectance, luminous reflectance and adhesion properties of the resulting substrate (4) with a transparent conductive film were evaluated.

The results are set forth in Table 1.

### EXAMPLE 5

### Preparation of Dispersion of Silica Particles (C)

A dispersion of silica particles (A) was prepared in the same manner as in Example 1. Then, the dispersion was adjusted to pH 4.0 by the use of dilute hydrochloric acid and heated at 200° C. for 1 hour in an autoclave. Subsequently, a cation exchange resin was added, followed by stirring for 1 hour to perform dealkalization. After the cation exchange resin was separated, an anion exchange resin was added, followed by stirring for 1 hour to perform deanionization. Thus, a dispersion of silica particles (C) having a SiO₂ concentration of 5% by weight was prepared. As for the chain silica particles, about 3 to 5 silica particles were connected (average number of particles connected: 3, length: 30 nm), and the Na content in the silica particles was 30 ppm.

### Preparation of Coating Liquid (5) for Forming Transparent Conductive Film

A coating liquid (5) for forming a transparent conductive film having a solids concentration of 0.4% by weight was prepared in the same manner as in Example 1, except that the dispersion of chain silica particles (C) was used.

### Preparation of Substrate (5) with Transparent Conductive Film

A substrate (5) with a transparent conductive film was obtained in the same manner as in Example 1, except that the coating liquid (5) for forming a transparent conductive film was used.

The surface resistivity, haze, bottom reflectance, luminous reflectance and adhesion properties of the resulting substrate (5) with a transparent conductive film were evaluated.

The results are set forth in Table 1.

### EXAMPLE 6

### Preparation of Coating Liquid (6) for Forming Transparent Conductive Film

A coating liquid (6) for forming a transparent conductive film having a solids concentration of 0.4% by weight was prepared in the same manner as in Example 5, except that the dispersion of metallic fine particles (1), the dispersion of chain silica particles (C) and the polar solvent were mixed in such amounts that the WB/WA weight ratio became 0.05.

### Preparation of substrate (6) with Transparent Conductive Film

A substrate (6) with a transparent conductive film was obtained in the same manner as in Example 1, except that the coating liquid (6) for forming a transparent conductive film was used.

The surface resistivity, haze, bottom reflectance, luminous reflectance and adhesion properties of the resulting substrate (6) with a transparent conductive film were evaluated.

The results are set forth in Table 1.

### EXAMPLE 7

### Preparation of Coating Liquid (7) for Forming Transparent Conductive Film

A coating liquid (7) for forming a transparent conductive film having a solids concentration of 0.4% by weight was prepared in the same manner as in Example 5, except that the dispersion of metallic fine particles (1), the dispersion of chain silica particles (C) and the polar solvent were mixed in such amounts that the WB/WA weight ratio became 0.25.

### Preparation of Substrate (7) with Transparent Conductive Film

A substrate (7) with a transparent conductive film was obtained in the same manner as in Example 1, except that the coating liquid (7) for forming a transparent conductive film was used.

The surface resistivity, haze, bottom reflectance, luminous reflectance and adhesion properties of the resulting substrate (7) with a transparent conductive film were evaluated.

The results are set forth in Table 1.

### EXAMPLE 8

### Preparation of Dispersion of Metallic Fine Particles (2)

A dispersion of metallic fine particles (2) was prepared in the same manner as in Example 1, except that the aqueous solution of silver nitrate and palladium nitrate was added in such an amount that the weight ratio of Ag/Pd became 6/4. The average particle diameter of the metallic fine particles was 8 nm and the concentration of the dispersion was 10% by weight.

### Preparation of Coating Liquid (8) for Forming Transparent Conductive Film

A coating liquid (8) for forming a transparent conductive film having a solids concentration of 0.4% by weight was prepared in the same manner as in Example 5, except that the dispersion of metallic fine particles (2) was used.

### Preparation of substrate (8) with Transparent Conductive Film

A substrate (8) with a transparent conductive film was obtained in the same manner as in Example 1, except that the coating liquid (8) for forming a transparent conductive film was used.

The surface resistivity, haze, bottom reflectance, luminous reflectance and adhesion properties of the resulting substrate (8) with a transparent conductive film were evaluated.

The results are set forth in Table 1.

### COMPARATIVE EXAMPLE 1

### Preparation of Coating Liquid (R-1) for Forming Transparent Conductive Film

A coating liquid (R-1) for forming a transparent conductive film having a solids concentration of 0.4% by weight was prepared in the same manner as in Example 1, except that the dispersion of metallic fine particles (1) and a polar solvent (water: 82% by weight, butyl cellosolve: 16% by weight, N-methyl-2-pyrrolidone: 2% by weight) were mixed.

### Preparation of Substrate (R-1) with Transparent Conductive Film

A substrate (R-1) with a transparent conductive film was obtained in the same manner as in Example 1, except that the coating liquid (R-1) for forming a transparent conductive film was used.

The surface resistivity, haze, bottom reflectance, luminous reflectance and adhesion properties of the resulting substrate (R-1) with a transparent conductive film were evaluated.

The results are set forth in Table 1.

### COMPARATIVE EXAMPLE 2

### Preparation of Dispersion of Silica Particles (D)

A dispersion of silica particles (D) having a SiO₂ concentration of 5% by weight was prepared in the same manner as in Example 1, except that a silica sol (SS-300, available from Catalysts & Chemicals Industries Co., Ltd., average particle diameter: 300 nm, SiO₂ concentration: 20% by weight, Na in silica: 1900 ppm) was used. The Na content in the silica particles was 100 ppm.

### Preparation of Coating Liquid (R-2) for Forming Transparent Conductive Film

A coating liquid (R-2) for forming a transparent conductive film having a solids concentration of 0.4% by weight was prepared in the same manner as in Example 1, except that the dispersion of silica particles (D) was used.

### Preparation of Substrate (R-2) with Transparent Conductive Film

A substrate (R-2) with a transparent conductive film was obtained in the same manner as in Example 1, except that the coating liquid (R-2) for forming a transparent conductive film was used.

The surface resistivity, haze, bottom reflectance, luminous reflectance and adhesion properties of the resulting substrate (R-2) with a transparent conductive film were evaluated.

The results are set forth in Table 1.

TABLE 1

| | Coating liquid for forming transparent conductive film | | | | | | | |
|---|---|---|---|---|---|---|---|---|
| | | Metallic fine | | | | | | |
| | | particles | | Silica particles | | | | |
| | | | Average | | Average | Average | | |
| | | | particle | | particle | number of | | Concen- |
| | | | diameter | Shape | diameter | particles | WB/ | tration |
| | No. | Type | (nm) | (No.) | (nm) | connected | WA | (wt %) |
| Ex. 1 | 1 | Ag/Pd | 8 | Monodis- | 5 | — | 0.15 | 0.4 |
| | | (1) | | perse (A) | | | | |
| Ex. 2 | 2 | Ag/Pd | 8 | Monodis- | 5 | — | 0.05 | 0.4 |
| | | (1) | | perse (A) | | | | |
| Ex. 3 | 3 | Ag/Pd | 8 | Monodies- | 5 | — | 0.25 | 0.4 |
| | | (1) | | perse (A) | | | | |
| Ex. 4 | 4 | Ag/Pd | 8 | Monodies- | 10 | — | 0.15 | 0.4 |
| | | (1) | | perse (B) | | | | |
| Ex. 5 | 5 | Ag/Pd | 8 | connected | 10 | 3 | 0.15 | 0.4 |
| | | (1) | | (C) | | | | |
| Ex. 6 | 6 | Ag/Pd | 8 | connected | 10 | 3 | 0.05 | 0.4 |
| | | (1) | | (C) | | | | |
| Ex. 7 | 7 | Ag/Pd | 8 | connected | 10 | 3 | 0.25 | 0.4 |
| | | (1) | | (C) | | | | |
| Ex. 8 | 8 | Ag/Pd | 8 | connected | 10 | 3 | 0.15 | 0.4 |
| | | (2) | | (C) | | | | |
| Comp. | | Ag/Pd | 8 | — | — | — | — | 0.4 |
| Ex. 1 | | (1) | | | | | | |
| Comp. | | Ag/Pd | 8 | Monodis- | 300 | — | 0.15 | 0.4 |
| Ex. 2 | | (1) | | perse(D) | | | | |

| | Cathode ray tube | | | | | | | |
|---|---|---|---|---|---|---|---|---|
| | Thickness of | Thickness | | | | | | |
| | conductive | of trans- | Adhesion | Film | | | | |
| | fine | parent | properties | strength | Surface | Bottom | Luminous | |
| | particle | film | Eraser | Scratch | resistivity | reflectance | reflectance | Haze |
| | layer (nm) | (nm) | test | test | (Ω/□) | (%) | (%) | (%) |
| Ex. 1 | 20 | 80 | A | A | 700 | 0.3 | 0.5 | 0.1 |
| Ex. 2 | 20 | 80 | B | B | 550 | 0.2 | 0.5 | 0.1 |
| Ex. 3 | 20 | 80 | A | A | 900 | 0.5 | 0.7 | 0.1 |
| Ex. 4 | 20 | 80 | A | A | 700 | 0.3 | 0.5 | 0.1 |
| Ex. 5 | 20 | 80 | A | A | 680 | 0.3 | 0.5 | 0.1 |
| Ex. 6 | 20 | 80 | B | B | 520 | 0.2 | 0,5 | 0.1 |
| Ex. 7 | 20 | 80 | A | A | 950 | 0.5 | 0.7 | 0.1 |
| Ex. 8 | 20 | 80 | A | A | 800 | 0.3 | 0.5 | 0.1 |
| Comp. | 20 | 80 | C | C | 500 | 0.2 | 0.7 | 0.1 |
| Ex. 1 | | | | | | | | |
| Comp. | 20 | 80 | C | C | 900 | 0.6 | 0.9 | 1.0 |
| Ex. 2 | | | | | | | | |

What is claimed is:

1. A coating liquid for forming a transparent conductive film, comprising:
conductive fine particles having an average particle diameter of 1 to 200 nm,
silica particles having an average particle diameter of 4 to 200 nm, and
a polar solvent.

2. The coating liquid for forming a transparent conductive film as claimed in claim 1, wherein the silica particles are in the form of chain silica particles having 2 to 10 silica particles on an average being connected.

3. The coating liquid for forming a transparent conductive film as claimed in claim 1 or 2, wherein the content of an alkali in the silica particles is not more than 1000 ppm in terms of an alkali metal M.

4. The coating liquid for forming a transparent conductive film as claimed in any one of claims 1 to 3, wherein the weight ratio (WB)/(WA) of the silica particles (WB) to the conductive fine particles (WA) is in the range of 0.01 to 0.4.

5. The coating liquid for forming a transparent conductive film as claimed in any one of claims 1 to 4, wherein the conductive fine particles are metallic fine particles of one or more metals selected from the group consisting of Au, Ag, Pd, Pt, Rh, Ru, Cu, Fe, Ni, Co, Sn, Ti, In, Al, Ta and Sb.

6. A substrate with a transparent conductive film, comprising:
a substrate,
a transparent conductive fine particle layer formed on the substrate and comprising conductive fine particles having an average particle diameter of 1 to 200 nm, and silica particles having an average particle diameter of 4 to 200 nm and/or chain silica particles having 2 to 10 silica particles on an average being connected, and
a transparent film provided on the transparent conductive fine particle layer and having a refractive index lower than that of the transparent conductive fine particle layer.

7. A display device including a front side plate constituted of the above-mentioned substrate with a transparent conductive film as claimed in claim 6, said transparent conductive film being present on the outer surface side of the front side plate.
